(19) United States
(12) Patent Application Publication
(10) Pub. No.: US 2011/0108656 A1
(43) Pub. Date: May 12, 2011

(54) HALF SPOOL

(76) Inventor: Joel Voisad, Long Island City, NY (US)

(21) Appl. No.: 12/615,987

(22) Filed: Nov. 10, 2009

(51) Int. Cl. B65H 75/04; B65H 75/26; B65H 54/10; B65H 54/12; B23P 11/00

(52) U.S. Cl. 242/470; 242/613.2; 242/590; 29/428

(57) ABSTRACT

A half spool comprising an arcuate spool member for supporting an elongated flexible member such that said elongated flexible member can be wound around an outer circumference of said arcuate spool member, and at least one sidewall member abutting at least one side of the arcuate spool member to form a sidewall of the half spool and adapted to prevent slipping of the elongated flexible member wound around the arcuate spool member.

### FIELD OF THE INVENTION

This invention relates to a half spool for use with ribbons or other woundable materials and, more particularly, to a half spool having a semicircular shape.

### BACKGROUND OF THE INVENTION

When woundable materials, such as ribbons, rope, wires and the like are displayed or offered to users at a point of sale, such materials are typically wound around a conventional round spool, which serves to display the woundable material and from which the material can be dispensed by a user. At the point of sale, such conventional round spools are typically hung from a wall hanger. However, when the round spools are hung from a wall hanger, they typically require a significant amount of product display space in order to effectively display the product wound around the round spool to the consumer. In particular, when a conventional round spool is hung on a typical wall display hanger so that the woundable product is displayed to face the consumer, the round spool takes up a significant length of the wall hanger, thus limiting the number of such spools that can be hung.

It is, therefore, desirable to provide a spool configuration which is capable of hanging from a conventional wall hanger in a manner which saves space and provides easy access and product viewability to consumers. It is also desirable to provide a spool configuration that can effectively display any woundable materials, including decorative fabrics, ribbons, decorative ropes and wires.

It is, therefore, an object of the present invention to provide a hanging spool that has a space-saving configuration while effectively displaying the material wound around the spool. It is a further object of the invention to provide a spool configuration that allows easy access to individual spools on a conventional wall or display hanger that supports multiple hanging spools.

### SUMMARY OF THE INVENTION

A half spool is provided which comprises an arcuate spool member for supporting an elongated flexible member such that the elongated flexible member can be wound around an outer circumference of the arcuate spool member, and at least one sidewall member abutting at least one side of the arcuate spool member to form a sidewall of the half spool and adapted to prevent slipping of the elongated flexible member wound around the arcuate spool member. The arcuate spool member has a semi-circular cross-section, and the elongated flexible member comprises a decorative ribbon, lace, rope, wire or the like. In certain embodiments, the half spool further comprises a hanging member coupled with at least one of the arcuate spool member and the sidewall member, and adapted to support the half spool on a wall hanger.

In certain embodiments, the arcuate spool member includes a convex front surface, an opposing concave back surface and first and second sides. The half spool includes a first sidewall member abutting the first side of the arcuate spool member and a second sidewall member abutting the second side of the arcuate spool member, wherein the first and second sidewall members extend beyond the convex front surface of the spool member and beyond the concave back surface of the spool member. In the illustrative embodiments described, each sidewall member is substantially flat and has a crescent shape, and when the sidewall member abuts a side of the spool member, the sidewall member covers the entire side of the spool member. In addition, in some embodiments, each of the sidewall members includes a slit-like opening at one end, and the hanging member includes corresponding slit-like openings disposed at predetermined positions for engagement with the slit-like openings of the sidewall members. The spool member may be coupled with at least one sidewall using an adhesive.

The present invention, as described herein below, also includes half spools formed from a plurality of spool members for supporting a plurality of elongated flexible members. Moreover, a method of manufacturing and assembling the half spool is described.

### BRIEF DESCRIPTION OF THE DRAWINGS

The following description, given by way of example and not intended to limit the present invention solely thereto, will be best appreciated in conjunction with the accompanying drawings, wherein like reference numerals denote like elements and parts, in which:

FIG. 1 is a schematic illustration of a side view of a half spool of the present invention disposed on a wall hanger;

FIG. 2 is a schematic illustration of a front view of the half spool of the present invention disposed on a wall hanger;

FIG. 3 is a schematic illustration of the individual components of the half spool of FIGS. 1 and 2;

FIG. 4 is a schematic illustration demonstrating assembly of the individual components of the half spool of FIGS. 1-3;

FIG. 5 is a schematic illustration of the half spool of the present invention resulting from the assembled individual components of FIGS. 3 and 4;

FIG. 6 is a schematic illustration of multiple half spools of the present invention disposed on a wall hanger;

FIG. 7 is a schematic illustration of a side view of a double half spool of the present invention disposed on a wall hanger;

FIG. 8 is a schematic illustration of a front view of the double half spool of the present invention disposed on a wall hanger;

FIG. 9 is a schematic illustration of the individual components of the double half spool of FIGS. 7 and 8;

FIG. 10 is a schematic illustration of how the individual components of the double half spool of FIG. 9 are assembled;

FIG. 11 is a schematic illustration of the double half spool of the present invention resulting from the assembled individual parts of FIGS. 9 and 10; and

FIG. 12 is a schematic illustration of multiple double half spools of the present invention disposed on the wall hanger.

### DETAILED DESCRIPTION OF THE INVENTION

The present invention is directed to a half spool for displaying a spool or a roll of an elongated flexible member or material, including decorative fabrics, ribbons, lace, ropes, wire and the like. The half spool is configured to be hung from a conventional wall hanger and has a space-saving configuration so as to enable multiple half spools to be hung from the same wall hanger while providing easy access to, and view of, the elongated flexible member wound around each half spool.

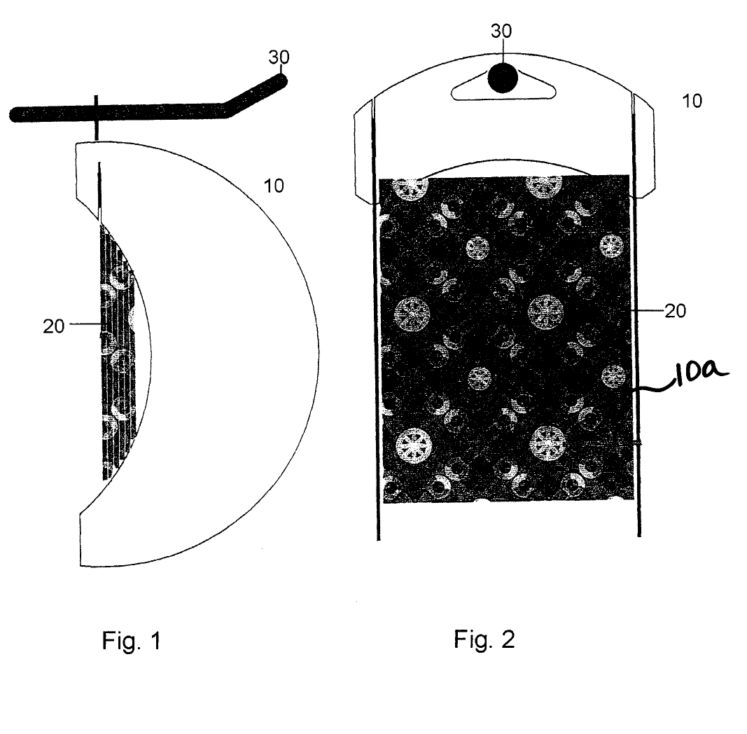

Referring now to the drawings, FIG. 1 is a schematic illustration of a side view of the half spool 10 of the present invention and FIG. 2 is a schematic illustration of a front view of the half spool. As shown in FIG. 1, the half spool 10 has a substantially semicircular shape when viewed from the side, and when disposed on a wall hanger 30, the half spool extends outwardly from the wall's horizontal plane. As shown in FIGS. 1 and 2, the orientation of the half spool 10 on the wall hanger 30 is such that the curved front portion 10a of the half spool 10 faces outwardly from the wall on which the wall hanger is mounted. In this way, the curved front portion 10a of the half spool 10 faces the consumer so as to directly display to the consumer the flexible material wound on the half spool.

As shown in FIG. 2, the half spool 10 provides an unobstructed view of the flexible material wound on the half spool 10 across the curved front portion 10a of the half spool. In particular, the curved front portion 10a of the half spool 10 displays a sufficient length of the flexible material 20 to allow the viewer to appreciate the quality and color of the flexible material 20 as well as any texture or patterns on the flexible material. In the illustrative example shown in FIGS. 1 and 2, the flexible material is a decorative ribbon, which is wound around, and is supported by, the half spool and which is displayed so that a consumer can easily view the quality of the ribbon material and the patterns on the ribbon. As can be appreciated from FIGS. 1 and 2, the semicircular shape of the half spool 10 has the same display benefits of a conventional round spool, but requires substantially less display space on a wall hanger. The construction of the half spool 10 also makes it easier for the seller to display the product on conventional display hangers because the product directly faces the consumer.

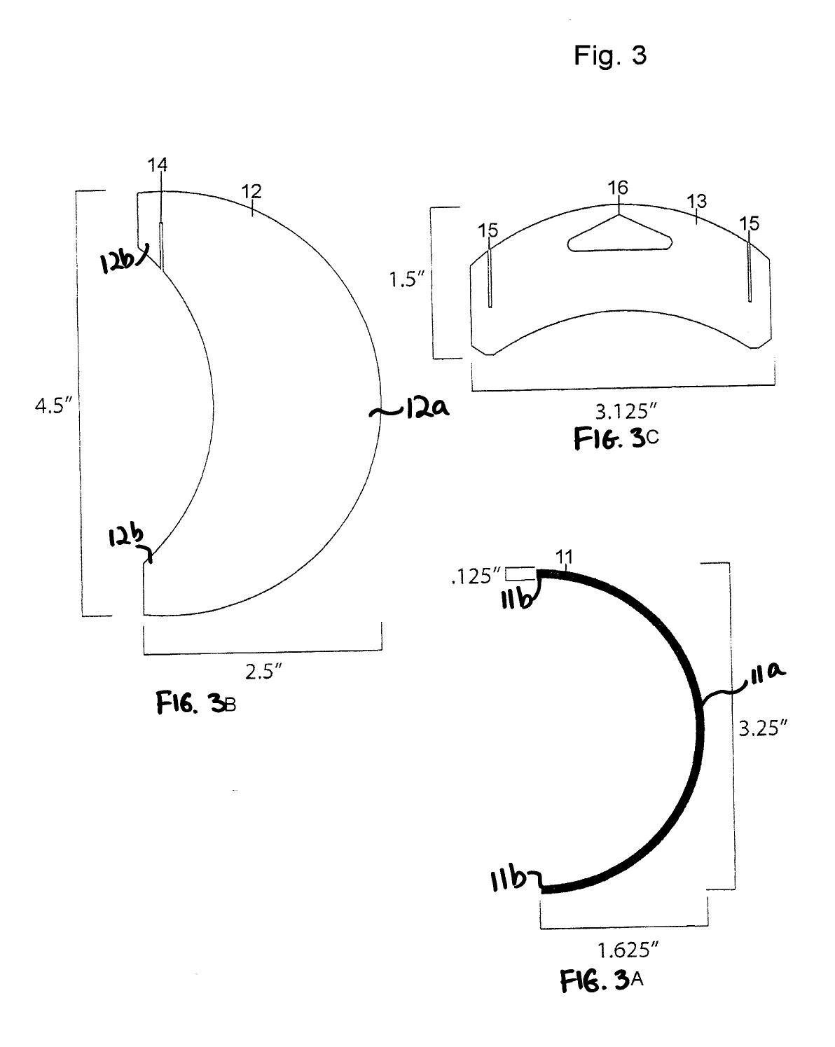

FIGS. 3A-3C schematically illustrate the individual components of the half spool 10 of FIGS. 1 and 2. As shown in the illustrative embodiment of FIGS. 3A-3C, the half spool 10 comprises a spool member 11, sidewall members 12 and a hanging member 13. FIG. 3A shows a side view of the spool member 11, which has an arcuate shape and forms a substantially semicircular or arch-like cross-section. A convex outer surface 11a of the spool member forms the curved front portion 10a of the half-spool when the spool member 11 is assembled with the other components. In the assembled half spool, the flexible material, such as a ribbon, is repeatedly wound around the spool member 11, so that each time the material is wound around the spool member, a portion of the material extends along the convex outer surface 11a of the spool member and another portion of the material extends between two ends 11b of the spool member 11. In this way, the spool member serves to support the flexible material, such as a ribbon, lace, rope and the like, wound around it.

The spool member 11 comprises material with sufficient strength and rigidity so as to support the flexible material and the remaining components of the half spool 10. Suitable materials include cardboard, plastic, rubberized or other synthetic materials, metal or metallic materials, wood, and the like. The size and dimensions of the spool member may vary so as to provide sufficient surface and support for the flexible material to be wound around the spool member. In the illustrative embodiment shown in FIGS. 1-3C, the half spool is used for supporting and displaying a decorative ribbon. FIG. 3A shows exemplary dimensions for the spool member 11 used for supporting a typical decorative ribbon, in which the spool member has a rise of 1.625 inches, a span of 3.25 inches and a thickness of 0.125 inches. The width of the spool member 11 can be varied depending on the width of the ribbon or other material supported by the half spool 10.

FIG. 3B shows one of the sidewall members 12 of the half spool 10, which, when assembled with the spool member 11 of FIG. 3A, abuts one side of the spool member 11 so as to form a sidewall of the half spool 10. Each sidewall member 12 is substantially flat so as to abut closely to the side of the spool member 11 when the half spool is assembled. The shape and size of the sidewall member 12 is dependent on the dimensions of the spool member 11 and on the desired shape of the half spool. In particular, the size of each sidewall member is at least equal to or greater than the size of the spool member 11 so that the sidewall member is able to cover the entire side of the spool member and, preferably extend beyond the span and rise of the spool member 11.

In the illustrative example of FIG. 3B, the sidewall member 12 is flat and has a crescent shape. The rise length and span length of the crescent-shaped sidewall member 12 are at least equal to, and preferably greater than, the rise and span of the spool member 11, respectively. In addition, the width of each sidewall member 12 decreases from a maximum width at a crescent's midpoint 12a on the span-axis to a minimum width at each end 12b of the sidewall member.

In FIG. 3B, the rise and span of the sidewall member 12 are greater than the rise and span of the spool member 11, so that when the sidewall member 12 abuts the spool member 11, the sidewall member extends beyond the outer convex surface 11a of the spool member, forming a sidewall in the front portion of the half spool. The sidewall member also extends beyond the opposing inner concave surface of the spool member 11, forming a sidewall in the back portion of the half spool. FIG. 3B provides exemplary dimensions of the sidewall member 12 that can be used with the spool member 11 having the dimensions indicated in FIG. 3A. In this illustrative embodiment, the dimensions of the sidewall member 12 have a rise of 2.5 inches and a span of 4.5 inches.

The sidewall members 12 can be formed from the same or a different material as the spool member 11. Suitable materials include cardboard, wax paper, plastic, rubberized or other synthetic materials, metal or metallic materials, wood, and the like. The material used for the sidewall members will be dependent on the type and the size of the flexible material that would be wound around the spool member and the type of material used for forming the spool member. In any case, the material used for the sidewall members should be lightweight and have sufficient strength to support the spool member 11 and to prevent slipping of the flexible member wound around the spool member.

As shown in FIG. 3B, each sidewall member 12 includes a slit-like opening 14 on the concave or inner edge of the crescent-shaped member. The slit-like opening 14 is positioned at one end of the sidewall member 12 and runs parallel to its span-axis. The slit-like opening 14 is used in assembling the sidewall member with the hanging member 13 of FIG. 3C which includes a corresponding slit-like opening 15 therein. The length of the slit-like opening 14 in the sidewall member depends on the size of the slit-like opening 15 in the hanging member. In the illustrative embodiment of FIG. 3B, the length of the slit-like opening 14 is about half of the width of the crescent at the position of the slit-like opening 14. It is understood that the position and shape of the opening 14 may vary depending on the assembly requirements and the corresponding openings in the hanging member 13. It is also understood that the sidewall member may have no openings for assembly with the hanging member and instead, an adhesive or another type of fastener, such as one or more clips or staples, may be used to fasten the sidewall member 12 to the hanging member.

FIG. 3C shows a hanging member 13 which, when assembled together with the sidewall members and the spool member, is used for hanging the half spool on a wall hanger. As shown in FIG. 3C, the hanging member 13 of the present illustrative embodiment, is substantially flat and has an arch-like shape. In this illustrative embodiment, the span or width of the hanging member is greater than the width of the spool member 11 so as to allow for assembly of the hanging member with two sidewall members 12. However, it is understood that in other embodiments, the shape and size of the hanging member 13 may vary depending on the way the hanging member 13 is assembled with, or coupled to, the sidewall members 12 and/or the spool member 11.

FIG. 3C provides exemplary dimensions of the hanging member 13 used together with the spool member 11 having the dimensions indicated in FIG. 3A and with the sidewall members 12 having the dimensions indicated in FIG. 3B. In the illustrative embodiment of FIG. 3C, the hanging member has a span or width of 3.125 inches and a rise or height of 1.5 inches.

The hanging member may be made from the same materials as the spool member 11 and/or the sidewall members 12. Suitable materials include, but are not limited to, cardboard, wax paper, plastic, rubberized or other synthetic materials, metal or metallic materials, wood, and the like. The material used for the hanging member is largely dependent on the type and size of the flexible material wound around the spool member and the total weight of the half spool 10. In any case, the material selected for the hanging member 13 should be lightweight and have sufficient strength to hold up the weight of the half spool when the half spool is hung on a wall hanger without bending or damaging the half spool.

As also shown in FIG. 3C, the hanging member 13 includes a pair of slit-like openings 15 extending from the top convex edge of the hanging member 13 through a portion of its height. The slit-like openings 15 in this illustrative embodiment are positioned near each side edge of the arch formed by the hanging member 13 and extend parallel to the span-axis of the hanging member's arch. As mentioned herein above, each of the slit-like openings 15 of the hanging member 13 is configured to engage with the slit-like opening 14 in the sidewall member 12 when the hanging member 13 is assembled together with the sidewall members 12. As shown in FIG. 3C, the two slit-like openings 15 in the hanging member 13 are separated by a width which is substantially equal to the width of the spool member 11. In this way, when each slit-like opening 15 is engaged with an opening 14 in the sidewall member 12, the spool member 11 can fit between the sidewall members 12 and can be coupled to each of the sidewall members.

The length of the slit-like openings 15 is dependent on the length of the opening 14 in the sidewall member 12 so that the hanging member 13 can be sufficiently coupled with the sidewall members to prevent disengagement and so that the hanging member 13 is not easily damaged when the slit-like openings 15 are engaged with the openings in the sidewall members. In the illustrative embodiment shown in FIG. 3C, the length of the slit-like openings 15 is equal to, or slightly greater than, the width of the hanging member 13. Although the illustrative embodiment of FIGS. 3A-3C shows engagement via slit-like openings between the hanging member 13 and the sidewall members 12, it is understood that the hanging member 13 can be coupled to the sidewall members 12 using other coupling means, such as adhesive or one or more staples or clips.

As also shown in FIG. 3C, the hanging member includes a central opening in the upper portion thereof, which allows a conventional wall hanger to pass therethrough when the assembled half spool is hung. Although the central opening is positioned in the upper portion of the hanging member and has a substantially triangular shape, it is understood that the positioning and the shape of the opening may vary. For example, a rounded opening may be used instead of the triangular opening. Moreover, in other embodiments, the hanging member 13 may include a different hanging means instead of an opening, such as a hook-like portion formed as part of the hanging member 13 or attached thereto.

As discussed herein above, the dimensions provided in FIGS. 3A-3C are exemplary and are not meant to limit the scope of the invention. The dimensions of the individual components of the half spool 10 may be varied. However, it is preferred that certain relationships between the individual components are maintained. In particular, the spool member 11 should have width that is equal to or greater than the elongated flexible material 20 to be wound on the half spool 10, and at least one of the rise and span of the sidewall members 12 should be equal to or greater than the respective at least one of the rise and span of the spool member 11. In addition, when the components of the half spool 10 have the construction shown in FIGS. 3A-3C, so that the hanging member 13 is configured to engage with each of the sidewalls, the width or span of the hanging member 13 should be at least equal to or greater than the width of the spool member 11, and the distance between the slit-like openings 15 should be approximately equal to the width of the spool member 11.

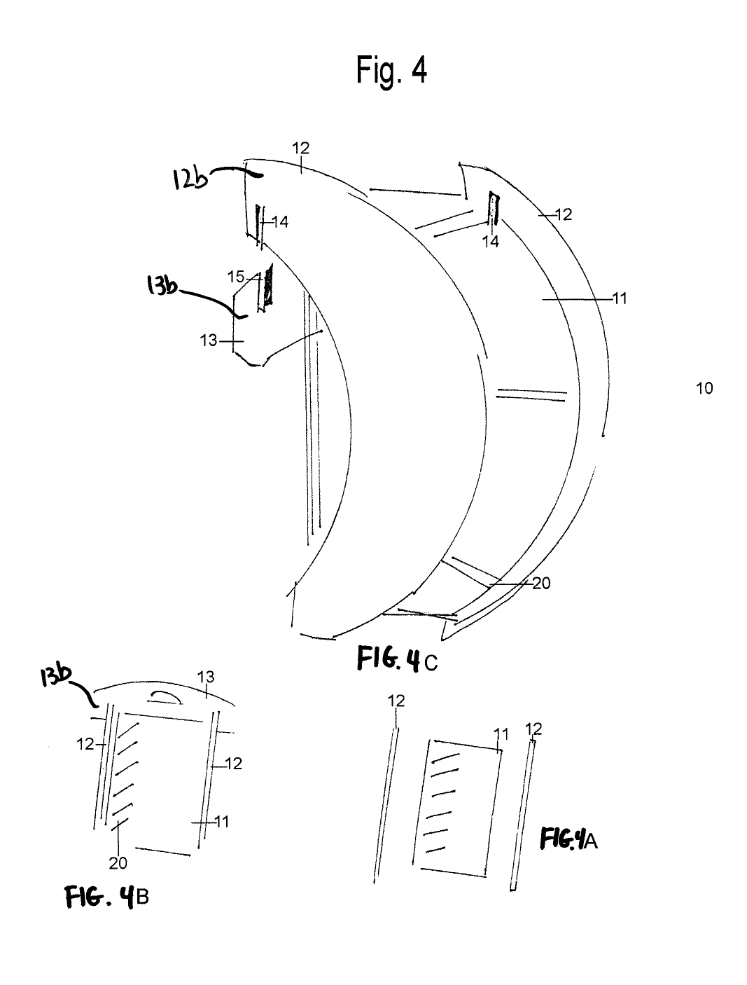

FIGS. 4A-4C schematically illustrate how the individual components of the half spool 10 of FIGS. 3A-3C are assembled. As shown in FIG. 4A, a sidewall member 12 is positioned on each side of the spool member 11 with the span-axis of each sidewall member 12 positioned parallel to the span-axis of the spool member 11. The side of the spool member 11 is positioned relative to the sidewall member 12 so that the sidewall member 12 extends along the entire side of the spool member 11 and preferably extends beyond the convex outer surface 11a of the spool member 11, forming a sidewall adjacent the spool member. In addition, the sidewall members 12 are oriented so that the end 12b with the slit-like opening 14 in each sidewall member 12 faces in the same direction.

As shown in FIG. 4B, the sidewall members 12 are attached to the spool member 11 using an adhesive material or another suitable coupling means. Selection and use of a suitable adhesive is dependent on the materials used and is known in the manufacturing field.

In the illustrative embodiment shown in FIGS. 4A-4C, the elongated flexible material 20, such as a ribbon, is wound around the spool member 11, forming a closed semi-circle around the spool member 11, prior to coupling the hanging member 13 to the sidewall members. However, it is understood that the hanging member 13 can be releasingly engaged with the sidewall members 12 prior to winding the flexible material around the spool member 11 and can be disengaged or released from the sidewall members 12 at a later time for ease of winding the flexible material around the spool member 11. As shown in FIG. 4C, when engaging the hanging member 13 with the sidewall members 12, the hanging member 13 and the sidewall members 12 are oriented so as to align the slit-like opening 14 in each sidewall member 12 with a respective slit-like opening 15 in the hanging member 13. The hanging member 13 can then be coupled to the sidewall members 12 by engaging the slit-like openings 14 of the sidewall members 12 with the slit-like openings 15 of the hanging member. As mentioned herein above, the lengths of the slit-like openings 14, 15 should be sufficient to ensure that the hanging member 13 is not easily disengaged from the sidewall members and also to ensure that the central opening 16 of the hanging member 13 is positioned above the spool member 11. In certain embodiments, each outer end 13b of the hanging member 13 that extends outside the slit-like opening 15 can be bent against the outer surface of the respective sidewall member 12 and adhered to the outer surface of the sidewall member 12 using an adhesive or another suitable coupling means. This ensures that the hanging member 13 remains engaged with the sidewall members 12.

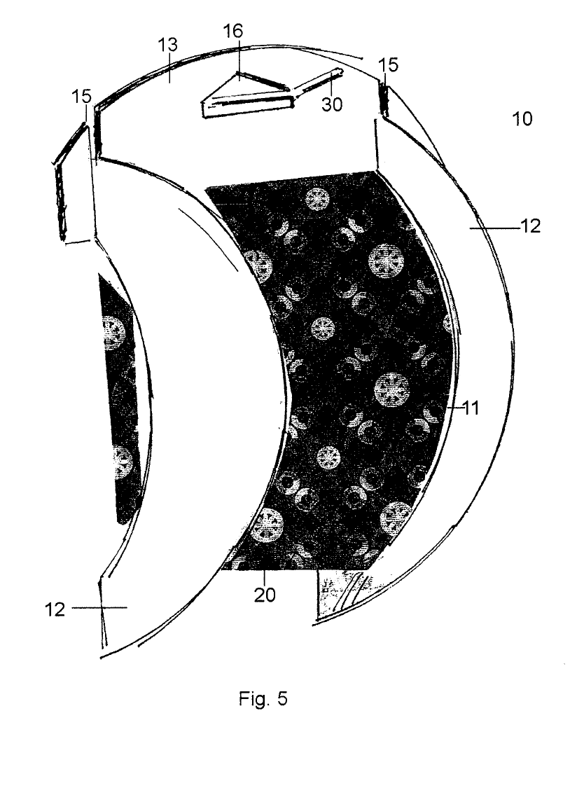

The assembled half spool 10 resulting from the assembly shown in FIGS. 4A-4C is shown in FIG. 5. As shown, the half spool 10 has a substantially semicircular shape and enables displaying of the flexible material 20 wound around the spool member 11. As can be seen, the half spool 10 in combination with the flexible material has a rigid curved front portion 10a that displays the flexible material and a flexible rear portion 10c. As shown, the elongated material 20 may be prevented from unwinding from the spool member 11 by the engagement of the hanging member 13 to the sidewall members 12. In addition, other means, such as a pin or an adhesive may be used to prevent the elongated material from unwinding from the half spool.

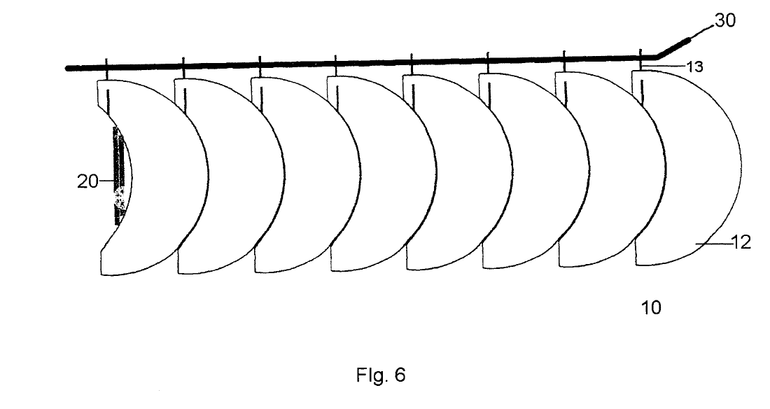

As discussed above, the configuration of the half spool enables efficient storage of, and access to, multiple half spools disposed on a single wall hanger 30. As shown in FIG. 6, multiple half spools 10 can be placed on a single wall hanger 30 and can be compressed in a nesting fashion so as to save space and make it possible to easily handle multiple half spools at once. Specifically, when the rigid curved front portion of a first half spool 10 is pushed into the flexible flat back portion of a second half spool 10, the rigid curved front portion can nest against the concave or inside edges of the sidewall members 12 of the second half spool 10. This nesting effect between adjacent half spools 10 and the semicircular shape of the half spool 10 provide for a more efficient use of the limited amount of space available on the wall hanger 30. Additionally, the nesting effect between adjacent half spools 10 limits movement between adjacent spools, which simplifies transport of the half spools. For example, as shown in FIG. 6, on a wall hanger that has eight half spools, the first four half spools may be easily removed by compressing them into a single nested unit, minimizing movement of the spools relative to one another as they are removed from the wall hanger.

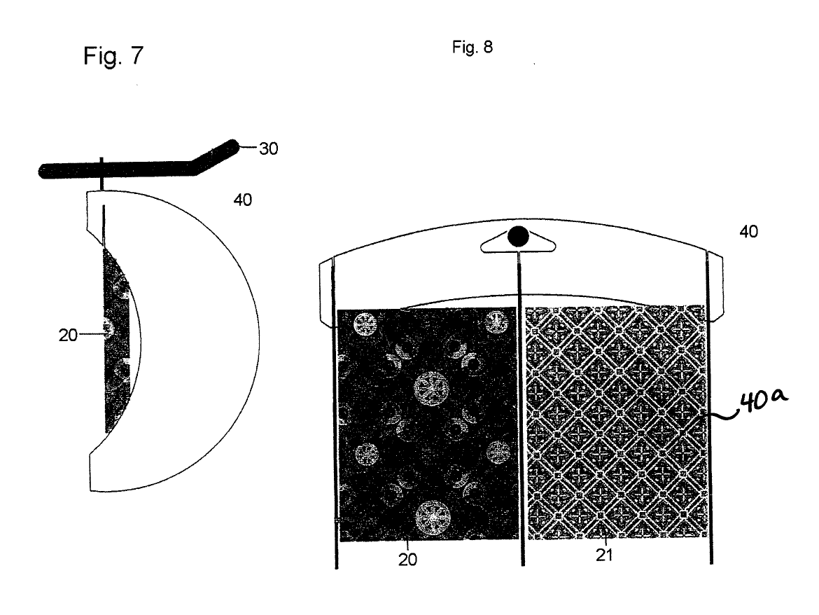

In a second embodiment of the present invention, the half spool assembly includes a plurality of spool members on which a plurality of elongated flexible materials may be wound. FIG. 7 is a schematic illustration of a side view and FIG. 8 is a schematic illustration of a front view of a double half spool 40 disposed on a wall hanger. As shown, the double half spool 40 enables two different flexible materials, such as two separate ribbons, to be separately wound on the half spool and displayed to the consumer as a combined package. As shown in FIGS. 7 and 8, the double half spool provides an unobstructed view of two separate elongated flexible materials 20 and 21, such as two ribbons. The double half spool 40 has similar benefits as the half spool of FIGS. 1-6.

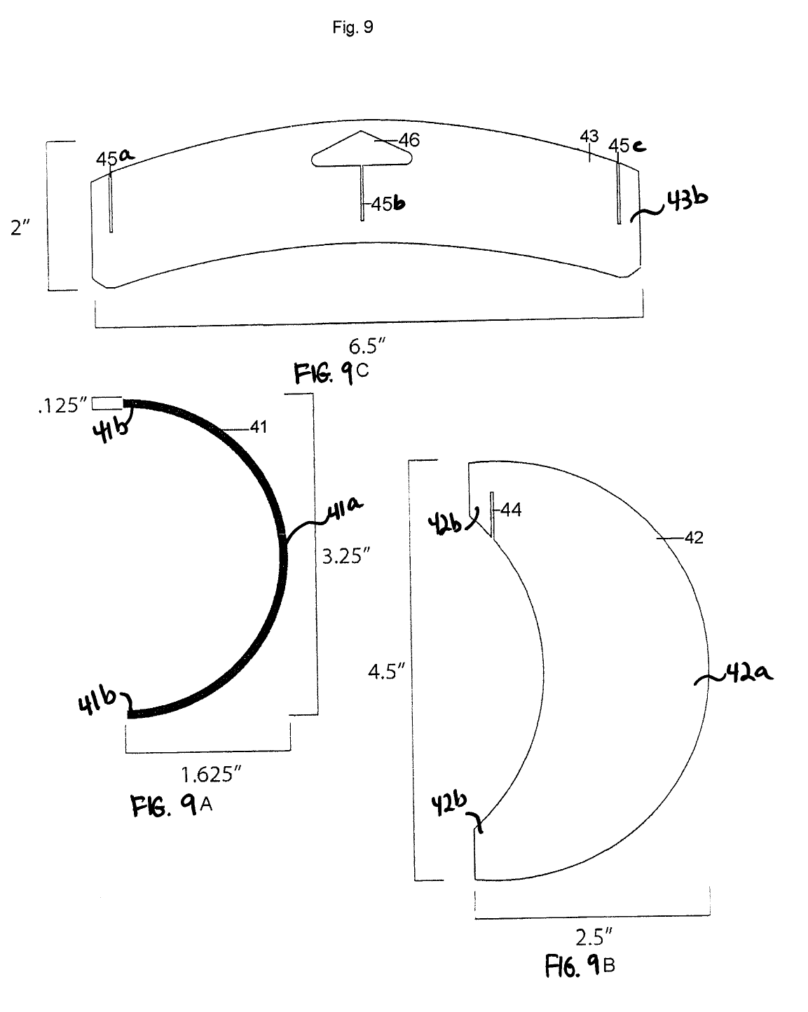

FIGS. 9A-9C show a schematic illustration of the individual components of the double half spool 40 of FIGS. 7 and 8. As shown, the double half spool 40 comprises two spool members 41, three sidewall members 42, including two sidewall members forming the outer sides of the half spool and one sidewall member positioned between the two spool members 42, and a hanging member 43.

The spool members 41 of FIG. 9A have a similar arcuate configuration and similar illustrative dimensions as the spool member 11 of FIG. 3A. Also, the sidewall members 42 shown in FIG. 9B have a similar configuration as the sidewall members 12 of FIG. 3B. In particular, the sidewall members 42 of FIG. 9B have a similar illustrative crescent shape and illustrative dimensions as the sidewall members 12 of FIG. 3B. Accordingly, a further description of the spool members 41 and the sidewall members 42 is omitted.

The hanging member 43 of the double half spool 40 is shown in FIG. 9C. When the hanging member 43 is assembled together with the sidewall members 42 and the spool members 41, the hanging member 43 is used for hanging the double half spool on a conventional wall hanger. As shown in FIG. 9C, the hanging member 43 is substantially flat and has a width or span that is at least equal to, or greater than, the width of the two spool members 41 so as to couple with the three sidewall members. In the illustrative embodiment shown in FIG. 9C, the hanging member has an arch-like shape and a width that is greater than the width of the two spool members 41. However, it is understood that in other embodiments, the shape and size of the hanging member 43 will vary depending on the method of assembly of the hanging member 43 with the sidewall members 42 and the spool members 41.

The hanging member 43 may be made from the same materials as the spool members 41 and/or the sidewall members 42. Similar to spool members 42 and/or sidewall members 42, suitable materials for forming the hanging member 43 include, but are not limited to, cardboard, wax paper, plastic, rubberized or other synthetic materials, metal or metallic materials, wood and the like materials. The material used for the hanging member 43 is dependent on the type and size of the flexible materials wound on the spool members 41 and the total weight of the double half spool 40. The material selected for the hanging member should be lightweight and have sufficient strength to hold up the weight of the half spool when the double half spool 40 is hung on a conventional wall hanger without bending or damaging the double half spool.

The hanging member 43 differs from the hanging member 13 of the first embodiment of FIGS. 3A-3C in that it has a width that is equal to or greater than the combined width of the two spool members 41. In addition, when assembled with the other components, the hanging member 13 extends across the top width of the two spool members 41. As mentioned herein above, the dimensions of the hanging member 43 vary depending on the width of the spool members 41 and the configuration of the double half spool 40. FIG. 9C shows exemplary dimensions of the hanging member 43 used together with the spool members 41 having the dimensions indicated in FIG. 9A and with the sidewall members 42 having the dimensions indicated in FIG. 9B. In the illustrative embodiment of FIG. 9C, the hanging member 43 has a width or span of 6.5 inches and a height or rise of 2 inches.

The hanging member 43 of FIG. 9C also differs from the previously described hanging member 13 in that it includes three slit-like openings 45a-c, each of which is used for engaging with a slit-like opening 44 of one sidewall member 42. As in the embodiment shown in FIG. 3C, the slit-like openings 45a and 45c extend from the top convex edge of the hanging member 43 through a portion of the height of the hanging member 43. Each of the slit-like openings 45a and 45c is engaged with a sidewall member 42 that forms an outer side of the double half spool 40. In the embodiment of FIG. 9C, a third slit-like opening 45b extends from a central opening 46 formed in the central portion of the hanging member 43. In particular, the slit-like opening 45b extends from a bottom edge of the central opening and through a portion of the height of the hanging member 43. In other illustrative embodiments, the hanging member 43 may include a hook-like portion instead of the central opening 46, which may be formed as part of the hanging member 43 or attached thereto. In such embodiments, the third slit-like opening 45b extends from a top edge of the hanging member 43 or may be formed in the central area of the hanging member 43.

The length of the slit-like openings 45a-c is dependent on the length of the openings 44 in the sidewall members 42 so that the hanging member 43 can be sufficiently coupled with the sidewall members 42 to prevent disengagement, and so that the hanging member is not easily damaged when the slit-like openings 45a-c are engaged with the openings 44 in the sidewall members. The length of the slit-like openings 45a-c in the illustrative embodiment of FIG. 9C is equal to, or slightly greater than, the total width of the hanging member 43.

Although the illustrative embodiment of FIGS. 9A-9C shows engagement of the hanging member 43 with the sidewall members 42 via slit-like openings, it us understood that the hanging member 43 may be coupled to the sidewall members using other coupling means such as an adhesive, or one or more staples or clips.

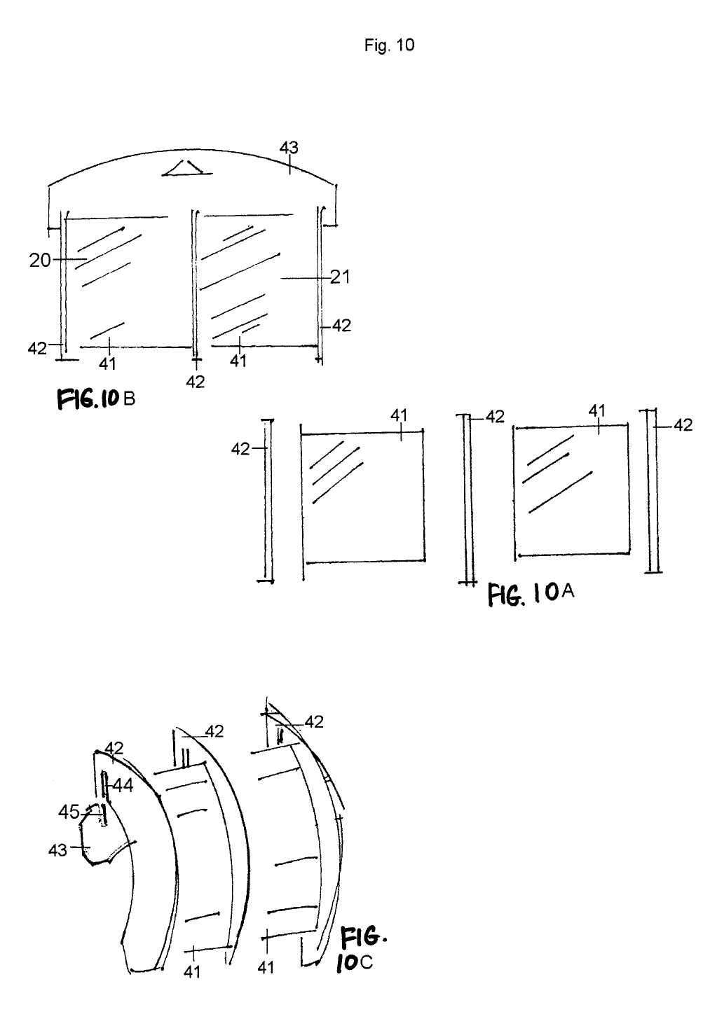

FIGS. 10A-10C schematically illustrate how the individual components of the double half spool 40 shown in FIGS. 9A-9C are assembled together. As shown in FIG. 10A, a sidewall member 42 is positioned between two adjacent spool members 41 and two sidewall members 42 are positioned at the outer sides of the two spool members 41. The sidewall members 42 are positioned relative to the spool members 41 so that each sidewall member 12 extends along the entire side of the abutting spool member 41 and preferably extends beyond the convex outer surface 41a of the spool member 41 so as to form a sidewall adjacent the spool member. In addition, the sidewall members 42 are oriented such that their ends 42b with the slit-like openings 44 face in the same direction.

As in the first embodiment, the sidewall members 42 in FIG. 10B are attached to the adjacent spool members 41 using an adhesive material or using another suitable coupling means. Selection of the suitable adhesive is dependent on the materials used for forming the sidewall members and/or for the spool members.

In the illustrative embodiment shown in FIGS. 10A-10C, the elongated flexible material, such as a ribbon, is wound around each spool member 41 so that the flexible material forms a closed semi-circle around the spool member 41, prior to coupling the hanging member 43 with the sidewall members 42. However, it is understood that the hanging member 43 may be releasingly engaged with the sidewall members 42 prior to winding the flexible materials around the spool members 41 and may be later disengaged from the sidewall members for ease of winding the flexible materials around the spool members 41.

As in the first embodiment, when the hanging member 42 is engaged with the sidewall members 42 as shown in FIG. 10C, the hanging member 43 and the sidewall members 42 are oriented so as to align the slit-like opening 44 of each sidewall member 42 with the slit-like openings 45a-c of the hanging member 43. In addition, in some embodiments, the outer ends 43b of the hanging member 43 that extend outside the slit-like openings 45a, 45c can be bent against the outer surface of the respective sidewall member 42 and adhered to the outer surface of the sidewall member 42 using an adhesive or another suitable coupling means. This ensures that the hanging member 43 remains engaged with the sidewall members 42.

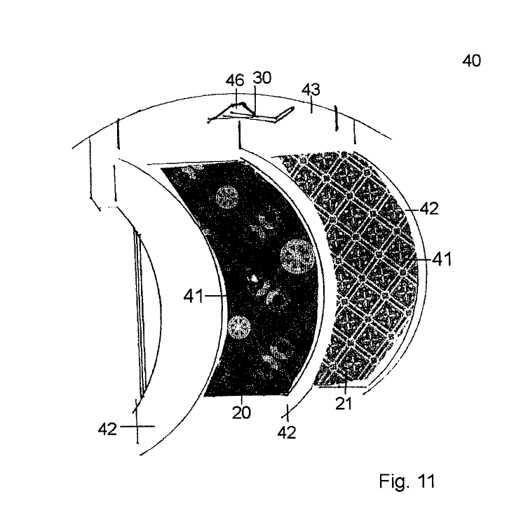

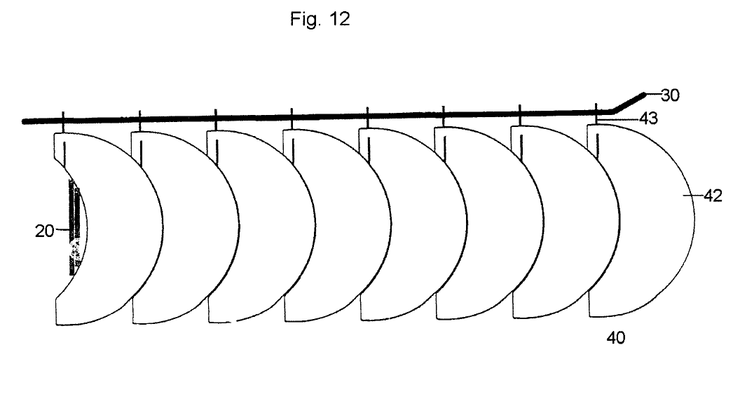

The assembled double half spool 40 resulting from the assembly shown in FIGS. 10A-10C is shown in FIG. 11. As can be seen, the double half spool 40 has a substantially semi-circular shape and enables winding and displaying of two different flexible materials 20. As in the first embodiment, the double half spool 40, in combination with two flexible materials 20, has a rigid curved front portion 10a that displays the flexible materials 20 and a flexible rear portion 10c. Also, as in the first embodiment, the elongated materials are prevented from unwinding from the spool members 41 by the engagement of the hanging member 43 with the sidewall members 42. In addition, other securing means, such as a pin or an adhesive may be used to prevent the elongated materials from unwinding from the double half spool 40.

As discussed above, the configuration of the double half spool enables efficient storage of, and access to, multiple half spools disposed on a single wall hanger 30. FIG. 12 illustrates multiple double half spools 40 being placed on a single wall hanger 30 and compressed in a nesting fashion, similar to the first embodiment shown in FIG. 6. As can be seen from FIG. 12, double half spool 40 provides for the same space saving benefits and nesting effect as the half spool of the first embodiment described herein above.

Although FIGS. 7-12 show a double half spool configuration for displaying two separate elongated materials, it is understood that other configurations of half spools may be provided which are capable of storing and displaying a greater number of different elongated materials. For example, triple half spool configuration, including three spool members and four sidewall members, may be used for displaying three separate elongated materials. Moreover, although the half spools shown in FIGS. 7-8 are used for displaying the same type of elongated material having the same or similar widths, it is contemplated within the invention that the half spools may be configured to store and display different types of elongated materials and/or materials of different widths. In such configurations, the spool members 41 included in the half spool having a plurality of spool members 41 may have different widths, with each of the spool members being adapted to store and display an elongated material of a different width.

In all cases it is understood that the above-described arrangements are merely illustrative of the many possible specific embodiments which represent applications of the present invention. For example, while the half spool described above is adapted to hang from a conventional wall hanger, the hanging member used in the spool may be omitted so that the half spool can be displayed on a shelf or as part of a set. Numerous and varied other arrangements can be readily devised in accordance with the principles of the present invention without departing from the spirit and scope of the invention.

What is claimed is:

1. A half spool, comprising:
an arcuate spool member for supporting an elongated flexible member such that said elongated flexible member can be wound around an outer circumference of said arcuate spool member; and
at least one sidewall member abutting at least one side of said arcuate spool member so as to form a sidewall of said half spool and adapted to prevent slipping of said elongated flexible member wound around said arcuate spool member.

2. A half spool in accordance with claim 1, wherein said arcuate spool member has a semi-circular cross section and said elongated flexible member comprises one of a decorative ribbon, lace, rope and wire.

3. A half spool in accordance with claim 1, further comprising:
a hanging member coupled with at least one of said arcuate spool member and said at least one sidewall member and adapted to support said half spool on a wall hanger.

4. A half spool in accordance with claim 3, wherein said hanging member is disposed at a top portion of said half spool and includes one of a central opening and hook member for supporting said half spool on a wall hanger.

5. The half spool in accordance with claim 3, wherein said arcuate spool member includes a convex front surface, an opposing concave back surface, and first and second sides, and said half spool includes a first sidewall member abutting said first side of said arcuate spool member and a second sidewall member abutting said second side of said arcuate spool member, and wherein said first and second sidewall members extend beyond the convex front surface and beyond the concave back surface so as to form sidewalls of said half spool.

6. A half spool in accordance with claim 5, wherein each of said first and second sidewall members is substantially flat and has a crescent shape and wherein, when each of said first and second sidewall members abuts a respective one of said first and second sides of said spool member, each said sidewall member covers the entire side of said spool member.

7. A half spool in accordance with claim 5, wherein:
said first side of said spool member is coupled with said first sidewall member using an adhesive;
said second side of said spool member is coupled with said second sidewall member using an adhesive; and
at least one of said first and second sidewall members is coupled with said hanging member using an engagement means included in at least one of said hanging member and said sidewall member.

8. A half spool in accordance with claim 7, wherein:
each of said first and second sidewall members includes a slit-like opening at one end of said sidewall member and said hanging member includes first and second slit-like openings disposed at predetermined positions for engagement with said first and second sidewall members;
said first sidewall member is coupled with said hanging member by engaging said slit-like opening in said first sidewall member with said first slit-like opening in said hanging member; and
said second sidewall member is coupled with said hanging member by engaging said slit-like opening in said second sidewall member with said second slit-like opening in said hanging member.

9. A half spool in accordance with claim 7, wherein:
said elongated flexible member supported by said half spool is a decorative ribbon,
said spool member has a width that is equal to or greater than a width of said decorative ribbon; and
said hanging member has a width that is equal to or greater than the width of said spool member.

10. A half spool comprising:
a plurality of arcuate spool members for supporting a plurality of elongated flexible members such that each said elongated flexible member can be wound around an outer circumference of a respective arcuate spool member; and
a plurality of sidewall members, each said sidewall member abutting a side of at least one of said arcuate spool members so as to form a sidewall and adapted to prevent slipping of said elongated flexible member wound around said at least one of said arcuate spool members.

11. A half spool in accordance with claim 10, wherein each said arcuate spool member has a semi-circular cross-section and each said elongated flexible member comprises one of a decorative ribbon, lace, rope and wire.

12. A half spool in accordance with claim 10, further comprising a hanging member coupled with at least one of: (i) one or more of said sidewall members; and (ii) one or more of said plurality of arcuate spool members, and adapted to support said half spool on a wall hanger.

13. A half spool in accordance with claim 12, wherein:
each said arcuate spool member includes a convex front surface, an opposing concave back surface and first and second sides;
said plurality of arcuate spool members are positioned in said half spool so that said convex front surface of each arcuate spool member faces in the same direction;
each of said plurality of sidewall members abuts at least one of a first side and a second side of at least one arcuate spool member; and
each said arcuate spool member is separated from another arcuate spool member in an adjacent position by a sidewall member.

14. A half spool in accordance with claim 13, wherein each of said sidewall members:
is substantially flat;
covers an entire side of each said arcuate spool member abutting said sidewall member; and
extends beyond the convex front surface of each said arcuate spool member abutting said sidewall member.

15. A half spool in accordance with claim 13, wherein said each of said sidewall members engages with said arcuate spool member abutting said sidewall member using an adhesive, and wherein at least one of said sidewall members is coupled with said hanging member using an engagement means provided in at least one of said hanging member and said sidewall member.

17. A half spool in accordance with claim 16, wherein:
each of said sidewall members includes a slit-like opening at one end of said sidewall member and said hanging member includes a plurality of slit-like openings corresponding to said slit-like openings in said sidewall members and disposed at predetermined positions for engagement with said sidewall members; and
each of said sidewall members is coupled with said hanging member by engaging said slit-like opening in said sidewall member with a corresponding slit-like opening in said hanging member.

18. A half spool in accordance with claim 13, wherein:
said plurality of elongated member supported by said half spool comprises a plurality of ribbons;
each said spool member has a width that is equal to or greater than a width of a respective ribbon supported by said spool member; and
said hanging member has a width that is equal to or greater than a total width of said plurality of spool members.

19. A method of manufacturing a half spool for supporting at least one elongated flexible member, said method comprising the steps of:
providing at least one arcuate spool member, wherein said elongated flexible member can be wound around an outer circumference of said arcuate spool member;
providing at least one sidewall member adapted to prevent slipping of said elongated flexible member wound around said arcuate spool member; and
coupling said at least one said arcuate spool member with at least one sidewall member.

20. A method of manufacturing a half spool in accordance with claim 19, wherein said coupling comprises adhering said at least one arcuate spool member to said at least one sidewall member using an adhesive.

21. A method of manufacturing a half spool in accordance with claim 20, further comprising:
providing a hanging member for supporting said half spool on a wall hanger; and
coupling said hanging member with at least one of said sidewall members using an engagement means in at least one of said hanging member and said sidewall member.

22. A method of manufacturing a half spool in accordance with claim 21, further comprising:
providing an elongated flexible member and winding said elongated flexible member around said at least one arcuate spool member,
wherein said elongated flexible member is wound around at least one said arcuate spool member prior to coupling said hanging member with at least one of said sidewall members.
